(19) United States
(12) Patent Application Publication
(10) Pub. No.: US 2014/0129446 A1
(43) Pub. Date: May 8, 2014

(54) INACTIVE CREDIT OR DEBIT CARD ACTIVATED BY A BIOMETRIC FEATURE FOR A LIMITED TIME OR NUMBER OF PURCHASES

(71) Applicant: JOHN S. WORONEC, Lambertville, MI (US)

(72) Inventor: JOHN S. WORONEC, Lambertville, MI (US)

(21) Appl. No.: 14/064,835

(22) Filed: Oct. 28, 2013

Related U.S. Application Data
(60) Provisional application No. 61/721,724, filed on Nov. 2, 2012.

(51) Int. Cl. G06Q 20/40; G06Q 20/34

(52) U.S. Cl. CPC G06Q 20/40145; G06Q 20/354
USPC 705/44

(57) ABSTRACT

A method of verifying ownership of credit or debit cards is disclosed. An apparatus is provided which can compare a biometric representation on the credit or debit card with a biometric feature of the purchaser. For example, the cardholder's fingerprint may be on the card. The apparatus would contain a spot for the purchaser to place the same portion of his finger that was used to create the biometric on the apparatus. The card would be inserted in the apparatus, and the apparatus would compare the fingerprint on the card with the fingerprint of the customer and if they matched, the card would be activated for a limited period of time, or a limited number of purchases. The apparatus may also comprise a remote biometric feature reader, such as a facial scanner or hand scanner.

### RELATED APPLICATION

This application is claiming the benefit, under 35 U.S.C. 119(e), of the provisional application filed Nov. 2, 2012 under 35 U.S.C. 111(b), which was granted Ser. No. 61/721,724. Application 61/721,724 is pending as of the filing date of the present application This provisional application is hereby incorporated by reference in its entirety.

### BACKGROUND OF THE INVENTION

Before the advent of credit cards, sales by retailers were normally only made for cash, or “on account” for good customers whom they knew would pay their bill. These sales made no extra “profit” (interest) for the retailer.

Once credit cards first appeared on the scene they were issued by retailers, such as department stores. However, almost simultaneously, the problem of how to make certain that the card was in the rightful position of the owner appeared.

In response to this problem, the banks assumed the possibility of any loss due to a customer not paying, but at the same time they wanted a way to verify ownership of the card. Many such systems came on the scene. Among them were those shown in US 2004/0058705 A1 to Morgan, et al.; US 2008/0120707 A1 to Ramia; US 2008/0217400 A1 to Portano; US 2007/0073619 A1 to Smith; US 2007/0057037 A1 to Woronec and US 2007/0034690 A1 to Schilling.

However, such systems became so complex and expensive, some even having computer chips in the credit cards, that the search for a relatively simple and inexpensive way of verifying ownership continued in the art.

How to gain back the advantage of simplicity and cost effectiveness for the retailers has eluded the art for a considerable period of time.

### SUMMARY OF THE INVENTION

The present invention shows how this problem is solved by providing a credit or debit card having a “biometric” of the cardholder provided on the credit or debit card. In one embodiment of the present invention, a self-contained apparatus which would be present at the point of purchase would compare the biometric on the credit card with the biometric of the purchaser. For example, the cardholder's fingerprint may be on the card. The self-contained apparatus would contain a spot for the purchaser to place the same portion of his finger that was used to create the biometric on the apparatus. The card would also be inserted in the apparatus, and the apparatus would compare the fingerprint on the card with the fingerprint of the customer and if they matched, the card would be activated for a limited period of time, or a limited number of purchases.

In another embodiment of the present invention, a remotely located biometric feature reader, such as a facial scanner or a hand scanner would be used. It would be located at a convenient, predetermined location. Information indicating the result of the biometric feature scan would be sent to a computer which would have in its memory information on one or more biometric feature scans. If the information from the remotely located biometric feature reader matched any of the stored biometric feature scans, the credit card would be activated.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a flow chart showing the steps involved in the practice of the present invention.

FIG. 2 is a flow chart showing the steps involved in the practice of a modification of the present invention.

### DETAILED DESCRIPTION OF THE PREFERRED EMBODIMENTS

Biometrics or biometric identification refers to the identification of humans by their characteristics or traits. Biometrics is used in computer science as a form of identification and access control. Biometric identifiers are the distinctive measurable characteristics used to label and describe individuals. Biometric identifiers are often categorized as physiological versus behavioral characteristics. Physiological characteristics are related to the shape of the body. Examples include, but are not limited to, finger prints, facial recognition, DNA, palm print, hand geometry, iris recognition, retina scans and odor or scent or voice recognition. Biometrics makes use of those characteristics which are universal, that is, found in each and every human being. These, and other attributes, are included in biometrics analysis because these characteristics don't change with the growing age of individuals. The characteristics involved in biometrics can't be stolen or copied so you can't expect anyone to steal your face or eye vessels to use them for illegitimate purposes. Biometrics as used in the present invention means any human characteristic which is universal, that is, found in each and every human being.

Because the present invention uses apparatus which does not require any connection to a central source of information in order to operate, but only to the merchant's own existing computer system, they are relatively inexpensive and can be afforded by most any retailer. It could also be connected to a central source. This gives rise to another feature of the present invention, and that is having the same card accepted by a number of retailers. In fact, in one of the preferred embodiments of the present invention a number of small retailers would form a network and a credit card holder may use his credit card at any of the stores in the network. In this manner, a “network” of small stores gains the advantages the big retailers have. This system may also be used with existing networks, such as Visa, MasterCard, American Express, and the like

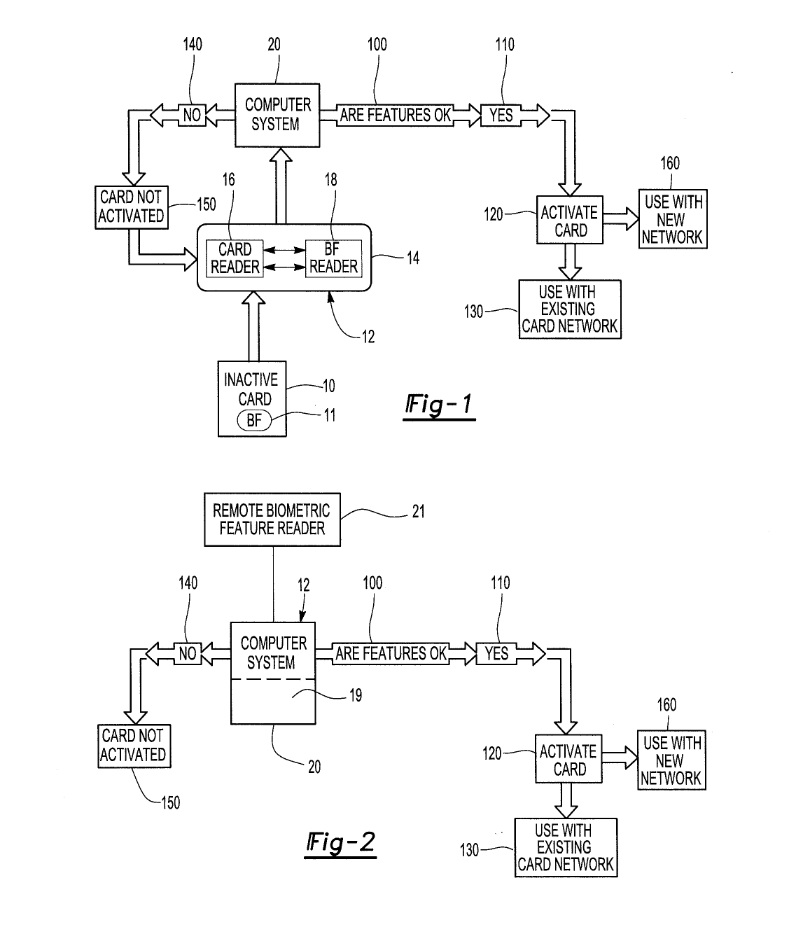

Referring to FIG. 1, the method of operation is shown. The cardholder will have an inactive credit or debit card 10 when entering an establishment that he wishes to purchase from. The card will have thereon information on a biometric feature (BF) 11 that the cardholder will need to have in order to have the card 10 activated. Such biometric feature 11 may be such as a fingerprint, hand scan, retina scan, or any other physiological biometric feature known in the art. The biometric feature 11 may be on the card as an actual feature, i.e. a thumbprint on the card 10′ or may be on the card in electronic, photographic, or any other form known in the art.

In order to activate the card 10 for a purchase, the card 10 will be inserted into a comparison device 12, such as a computer terminal 14 of the merchant or retailer. The comparison device 12 will have a card reader 16 which can read the biometric feature 11 of the cardholder from the card 10. The cardholder 10 will then permit the biometric feature reader 18 to read the corresponding biometric feature of the cardholder. The comparison device 12 will then compare the biometric feature 11 on the card 10 with the biometric feature of the cardholder. If biometric feature 11 on the card 10 matches the biometric feature of the cardholder, the card 10 will be activated for a predetermined number of purchases, or a predetermined period of time.

The comparison device 12 may be self-contained, having its own software, or may be connected to the merchants computer system 20, which will have its own software to make the comparison.

If the biometric feature 11 on the card 10 matches the biometric feature read by the biometric feature reader 18 (Box 100, 110), the card 10 will be activated (Box 120) by placing a suitable indication on the magnetic stripe of the card 10, or by any other method, such as an optical device. The card may be activated for a single purchase, any desired number of purchases, or for a desired period of time. The card 10 may then be used with an existing network (Box 130), or with a different, or new, network (Box 160).

If the biometric feature 11 on the card 10 does not match the biometric feature read by the biometric feature reader 18 (Box 140), the card 10 is not activated (Box 150), whereupon, the approval process may be retried, or the cardholder makes no further attempt to use the card 10 at the retailer.

Referring to FIG. 2, another modification of the present invention is illustrated. In this modification the merchant's computer system 20 becomes the comparison device 12. A remote biometric feature reader 21 (not located in comparison device 12) is connected to the computer system 20. The computer system 20 in this modification of the invention has sufficient memory 19 into which the merchant has loaded the biometric features of desirable purchasers or other classification of purchasers. The remote biometric feature reader 21, which may be such as a facial scanner, iris scanner, or the like, may be located at a convenient location in the merchant's store such as at the entry door. When the customer comes into the store, he will, for example, undergo a facial scan, and this will constitute the remotely read biometric feature of the purchaser, which must match the information in memory 19.

The remote biometric feature reader 21 then sends the information to the merchant's computer system 20. The computer system 20 then accesses memory 19 to determine if the biometric feature 11 read by the remote biometric feature reader 21 matches the biometric feature information contained in the computer memory 19 (Box 100), and if it does (Box 110), the purchaser's card may be activated by means known in the art (Box 120) and, as before, the card 10 may then be used with an existing network (Box 130), or with a different, or new, network (Box 160).

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A method of activating an inactive credit or debit card having a biometric feature for a limited time or number of purchases comprising the steps of:
a) providing a purchaser with a credit or debit card having information thereon representing a biometric feature of the purchaser;
b) providing a self-contained comparison device capable of comparing the biometric feature on the credit or debit card with the biometric of the purchaser;
c) having the purchaser place the credit or debit card on or in the self-contained comparison device;
d) having the purchaser place himself or herself with relation to the self-contained comparison device so that the self-contained comparison device can read the biometric of the purchaser;
e) causing the comparison device to read the biometric represented on the card and the biometric of the purchaser; and
f) activating the credit or debit card for a limited period of time, or a limited number of purchases, if the biometric represented on the card matches the biometric of the purchaser.

2. The method defined in claim 1, wherein the biometric feature is a physiological biometric feature.

3. The method defined in claim 2, wherein the physiological biometric feature is a facial scan.

4. The method defined in claim 2, wherein the physiological biometric feature is a hand print.

5. The method defined in claim 2, wherein the physiological biometric feature is a finger print.

6. The method defined in claim 2, wherein the physiological biometric feature is a retina scan.

7. The method defined in claim 2, wherein the physiological biometric feature is a voice print or recognition.

8. A method of activating an inactive credit or debit card of a customer for a limited time or number of purchases comprising the steps of:
a) providing a purchaser with a credit or debit card;
b) providing a comparison device capable of comparing a biometric of the purchaser taken by a remotely located biometric feature reader with a stored biometric feature.
e) causing the comparison device to read the biometric of the purchaser taken by the remotely located biometric feature reader and compare it with the stored biometric of the purchaser; and
f) activating the credit or debit card for a limited period of time or a limited number of purchases if the biometric on the card matches the biometric of the purchaser.

9. The method defined in claim 7, wherein the biometric feature is a physiological biometric.

10. The method defined in claim 8, wherein the physiological biometric feature is a facial scan.

11. The method defined in claim 8, wherein the physiological biometric feature is a hand print.

12. The method defined in claim 8, wherein the physiological biometric feature is a finger print.

13. The method defined in claim 8, wherein the physiological biometric feature is an eye scan.

14. The method defined in claim 8, wherein the physiological biometric feature is a facial scan.

15. The method defined in claim 8, where the physiological biometric is a voice print or recognition.
